(19) United States
(12) Patent Application Publication
(10) Pub. No.: US 2012/0293319 A1
(43) Pub. Date: Nov. 22, 2012

(54) Brake Light Illumination System

(76) Inventor: Steven Chew, Milpitas, CA (US)

(21) Appl. No.: 13/112,337

(22) Filed: May 20, 2011

(51) Int. Cl. B60Q 1/44

(52) U.S. Cl. 340/479

(57) ABSTRACT

A third brake lighting system for indicating the application of brakes in a vehicle comprising: a panic illumination portion, where the panic illumination indicates an urgent depression of the brakes by a driver of the vehicle; and a conventional illumination portion, where the convention illumination portion abuts the panic illumination portion and said conventional illumination indicates a non-urgent depression of the brakes by the driver. The present invention essentially provides mechanisms to indicate an urgent depression of the brakes by a driver of the vehicle; and mechanisms to indicate a non-urgent depression of the brakes by the driver of the vehicle.

### BACKGROUND OF THE INVENTION

1. Field of Invention

The present invention relates to the brake light illumination system that enables the urgency of braking applied by the user.

2. Description of Related Art

Automotive safety is an imperative function and essential when driving a vehicle. Many automobiles include various safety features such as seatbelts, airbags, antilock brakes, signaling systems, lighting systems and numerous sensors that may determine wheel slippage or tire wear. Every vehicle on the road includes a brake light system that initiates the illumination of rear lights upon the driver's application of the brake. This illuminated rear light system provides a visual notification to any following vehicles that the driver has applied his brakes, the vehicle is slowing down and may be coming to a halt. The rear brake light system therefore helps to avoid rear-end collisions. The brake light system is a standard feature on essentially every vehicle on the road. The braking system includes lights on each side of the rear panel, trunk and/or rear fender of the vehicle. Further, a third light is provided that is usually positioned either in the rear window or at the top of the rear panel of the vehicle. The third light is very effective during night driving where the rear driving lights are normally illuminated red. The illumination of the third light provides a clear indication to the following vehicles that the driver has applied the brake. In addition to the rear red light system providing signals for braking as stated above, the lights are illuminated during night driving and also the rear lights may flash to signal a turn when appropriate.

One disadvantage of the present brake light system is that there isn't a clear indication of urgency or the degree of application of the brake by the driver. If the driver were to slam on the brakes, then the brake lights turn the same degree of red as if the driver lightly applies the brake. Consequently, a following driver does not have indication of the urgency of the braking as being applied by the driver. It would therefore be advantageous to have a system that gave further indication of the degree of braking by the driver and therefore provide an additional safety feature of the tried and true brake light system.

### SUMMARY OF THE INVENTION

The present invention relates to a third brake lighting system for indicating the application of brakes in a vehicle comprising: a panic illumination portion, where the panic illumination indicates an urgent depression of the brakes by a driver of the vehicle; and a conventional illumination portion, where the convention illumination portion abuts the panic illumination portion and said conventional illumination indicates a non-urgent depression of the brakes by the driver. The present invention essentially provides a means to indicate an urgent depression of the brakes by a driver of the vehicle; and a means to indicate a non-urgent depression of the brakes by the driver of the vehicle. In one particular embodiment, the means to indicate the urgent depression includes at least one bulb and the means to indicate the non-urgent depression includes an illuminated panel, where the at least one bulb is positioned on the outer perimeter of the panel. In another particular embodiment, the means to indicate the urgent depression includes a strip of illuminated lighting and the means to indicate the non-urgent depression includes an illuminated panel, where said strip of illuminated lighting surrounds the outer perimeter of the illuminated panel. In yet another embodiment, the means to indicate the urgent depression includes illuminating an illumination panel at a first degree of brightness and the means to indicate the non-urgent depression includes illuminating the illumination panel at a second degree of brightness, where the first degree of brightness is greater than the second degree of brightness.

### BRIEF DESCRIPTION OF DRAWINGS

FIG. 1 depicts a first embodiment of a brake light illumination system according to the present invention.

FIG. 2 depicts a second embodiment of the brake lighting system according to the present invention.

FIG. 3 depicts a third embodiment of the brake lighting system according to the present invention.

FIG. 4 depicts a fourth embodiment of the brake lighting system according to the present invention.

### DETAILED DESCRIPTION

The present invention provides an illumination panel for a brake light system that provides an indication of the urgency of brake application by the driver. The present invention includes illumination screens and configurations that provide a clear indication that a vehicle is making an urgent or sudden braking due to the degree of force applied to the brake by the driver. The present invention provides a third light configuration and includes a predetermined lighting scheme that would be associated with an urgent braking situation. The present invention accomplishes this through providing a designated portion of the third brake light illumination, which gives indication of urgent application of the brakes. This indication is determined through the use of systems that may be placed in line with the braking system and therefore indicating an urgent or a quick and hard application of the brakes by the driver.

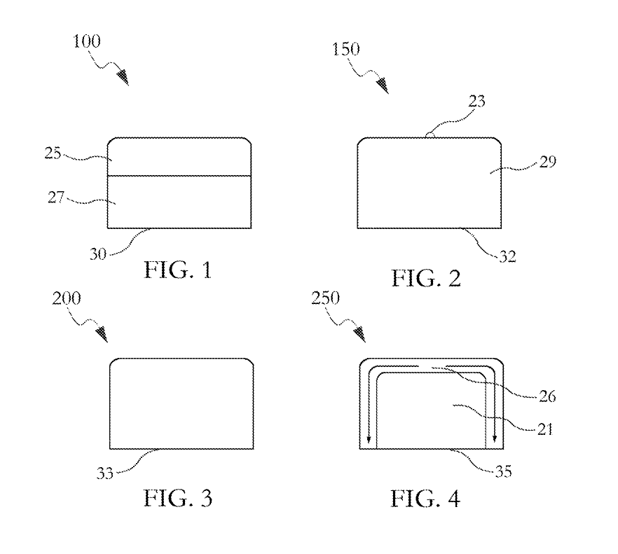

FIG. 1 depicts a first embodiment of a third brake lighting system 100 according to the present invention. The third brake lighting system 100 includes a brake light configuration 30. The brake light configuration 30 includes a panic illumination portion 25 and a conventional illumination portion 27. This split configuration provides a clear indication of the urgent application of the brakes has occurred. The panic illumination 25 lights in conjunction with the conventional illumination 27 when the driver executes an urgent application of the brakes. The panic illumination 25 may include a solid illumination, or in some instances, it may be programmed for a quick flashing light so that it is clear that an urgent braking condition is taking place.

FIG. 2 depicts a second embodiment of a third brake lighting system 150. The third brake lighting system 150 includes a light configuration 32 where the light configuration includes a conventional illumination screen 29. This illumination screen 29 takes up the entire portion of the brake light configuration 32. On top of this conventional illumination screen 29 is a bulb 23. This additional bulb 23 lights upon the urgent application of the brakes by the driver. Although depicted as a single bulb 23, the second embodiment of the third brake lighting system 150 may include a plurality of bulbs. With respect to this second embodiment, the bulb provides the indication of an urgent application of the brakes by the driver while the conventional illumination screen 29 provides an indication that a less urgent or a normal brake application is in progress.

FIG. 3 depicts a third brake light embodiment 200 according to the present invention. The brake light embodiment 200 includes a full illumination screen 33 very similar to the conventional third brake light currently in use. The full screen 33 provides two degrees of illumination. A conventional application of the brakes provides a less bright illumination of the filaments of the brake light 33. A more urgent or panicked application of brakes provides a substantially brighter illumination of the brake light configuration 33. Consequently, the third embodiment 200 is a configuration that is dependent upon the brightness of the illumination provided by the brake light 33.

FIG. 4 depicts a fourth embodiment, a third brake light embodiment 250 according to the present invention. This brake light embodiment 250 includes a brake light configuration 35. The brake light configuration 35 includes a standard conventional brake light illumination 21 surrounded by tracking lights 26. The tracking lights 26 surround the conventional illumination 21 and therefore indicates an urgent or panicked application of the brakes. The brake light embodiment 250 includes the tracking lights 26 that illuminates in a tracking manner around a conventional illumination screen 21. Upon the urgent application of the brakes by the driver, these tracking lights illuminate in a flashing or track lighting sequence. The illumination track 26 gives any following vehicles an indication that an urgent application of the brakes has occurred by the driver.

The present invention provides a third brake light configuration, which gives a clear indication of an urgent application of the brakes by the driver. This further indication provides a clear communication of the braking activities of the driver. The use of this third brake light system therefore provides an additional safety feature for safe driving and an additional method of reducing the likelihood of a rear-end collision. The instant invention has been shown and described in what it considers to be the most practical and preferred embodiments. It is recognized, however, that departures may be made there from within the scope of the invention and that obvious modifications will occur to a person skilled in the art.

What is claimed is:

1. A third brake lighting system for indicating the application of brakes in a vehicle comprising:
a. a panic illumination portion, where the panic illumination indicates urgent depression of the brakes by a driver of the vehicle; and
b. a conventional illumination portion, where the convention illumination portion abuts the panic illumination portion and said conventional illumination indicates a non-urgent depression of the brakes by the driver.

2. A third brake lighting system for indicating the application of brakes in a vehicle comprising:
a. a means to indicate a urgent depression of the brakes by a driver of the vehicle; and
b. a means to indicate a non-urgent depression of the brakes by the driver of the vehicle.

3. The third brake lighting system according to claim 2, where the means to indicate the urgent depression includes at least one bulb and the means to indicate the non-urgent depression includes an illuminated panel, where the at least one bulb is positioned on the outer perimeter of the panel.

4. The third brake lighting system according to claim 2, where the means to indicate the urgent depression includes a strip of illuminated lighting and the means to indicate the non-urgent depression includes an illuminated panel, where said strip of illuminated lighting surrounds the outer perimeter of the illuminated panel.

5. The third brake lighting system according to claim 2, where the means to indicate the urgent depression includes illuminating an illumination panel at a first degree of brightness and the means to indicate the non-urgent depression includes illuminating the illumination panel at a second degree of brightness, where the first degree of brightness is greater than the second degree of brightness.
